(19) United States
(12) Patent Application Publication
(10) Pub. No.: US 2002/0056136 A1
(43) Pub. Date: May 9, 2002

(54) System for converting existing TV content to interactive TV programs operated with a standard remote control and TV set-top box

(76) Inventors: Douglass A. Wistendahl, Bellport, NY (US); Leighton K. Chong, Honolulu, HI (US)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 09/815,020

(22) Filed: Mar. 21, 2001

Related U.S. Application Data
(63) Continuation-in-part of application No. 08/933,666, filed on Sep. 19, 1997.
Application No. 08/933,666 is a continuation-in-part of application No. 08/536,107, filed on Sep. 29, 1995.
Application No. 08/536,107 is a 371 of international application No. PCT/US96/15437, filed on Sep. 26, 1996.
(60) Provisional application No. 60/191,139, filed on Mar. 22, 2000.

(51) Int. Cl. H04N 7/173

(52) U.S. Cl. 725/135

(57) ABSTRACT

A method for converting existing media content to interactive media content defines “hot spots” in a display frame of TV program content to trigger an interactive response when a viewer “clicks” on the “hot spots”. The “hot spots” are defined by N Data representing their positions in the display area, and are not hyperlink codes embedded in digital video data. By avoiding embedded codes, the underlying TV content can remain uncorrupted, and the hot spot position data can be readily authored as adjunct data without having to edit and process each frame of the TV content. The hot spot positions can be defined as coordinate locations in the display area, and the positions can be haloed in the display image. Another version is to define the hot spots as marker positions in an HTML-type “page” that is parsed or overlaid to display the hot spots at the appropriate positions in the display area. A standard remote can be adapted as a pointing device by using its directional arrows to toggle among haloed “hot spot” positions. The set-top box can also have its detection program for the remote control signals modified so that a series of arrow button presses can be interpreted as pointing in increments in “staircase” fashion to a position in the display area. Another adaptation is to point with a vector ray to a hot spot in the display area by pressing the directional arrows on the standard remote control. Another variation of the system is to detect the viewer's pointing at objects in a display with a mouse or pointing device, and send them as “reverse hot spot” or “no spot” data upstream to the cable head-end, and ultimately to a program sponsor or advertiser for the TV program.

This patent application is a continuation-in-part from, and claims the priority benefit of, U.S. Provisional Application 60/191,139 filed on Mar. 22, 2000, and from co-pending U.S. patent application Ser. No. 08/933,666, filed Sep. 19, 1997, which was a continuation-in-part from PCT International Application PCT/US96/15437 filed on Sep. 26, 1996 as an international application originating in the United States under 35 U.S.C. 351(d), and from U.S. patent application Ser. No. 536,107, filed Sep. 29, 1995, issued as U.S. Pat. No. 5,708,845 on Jan. 13, 1998, all of which are incorporated herein by reference.

### FIELD OF THE INVENTION

This invention relates to the field of interactive media systems, and particularly to a system for converting existing TV content to interactive TV program operated with a standard remote control and TV set-top-box.

### BACKGROUND ART

Iteractive TV has held out the promise of richly interactive viewer experiences and, at the same time, enhanced capabilities for advertisers and vendors to reach targeted audiences and even individual viewers. However, despite many attempts to deliver interactive TV programs and services to TV viewers, obtaining a critical mass of public viewer interest has proved to be daunting. Some companies, such as WebTV and AOL-TV, have attempted to deliver Internet content with PC-type interactivity alongside or as an alternative to regular TV programs through cable TV or satellite TV links to advanced digital set-top boxes (STBs) operated with wireless keyboards and mouse controls. The general public has been slow to accept these types of interactive TV systems because of the high cost of purchasing the STB units and ongoing costs for online service. Moreover, Internet-based content tends to require active viewer navigation and direction, which is fundamentally different from the passive entertainment experience most viewers seem to prefer with regular TV programs. Other companies, such as Liberate and OpenTV, have attempted to offer a platform for delivering various interactive services on the TV, such as email, Internet surfing, local directories, online purchasing, electronic TV program guides, etc., on the peripheries of regular TV programming. Viewer response to the availability of such TV-based interactive services has been growing, but has been tempered by the availability of many other delivery channels for online services, coupled with the lack of compelling interactive TV programs.

The lack of compelling interactive TV programming or advertising appears to be the result of two thorny problems. One is the inertia of the TV programming and advertising production companies to produce TV content in the traditional way, i.e., as stories, ads, and other types of narrative scripts filmed with live actors which are intended to be viewed passively as entertainment. These industries will not underwrite the huge costs of producing and promoting new types of interactive content unless there is a clear demand for them by the viewing public. The other problem is the mindset of the TV hardware, middleware, and software programming industries that new types of interactive TV content must be delivered with new types of advanced digital platforms, user input devices and interfaces, Internet-based or PC-based content, and/or broadband connectivity. Viewers have resisted such attempts to foist new equipment, programming, or connectivity costs on them through their familiar and largely cost-free TV appliance in the absence of any critical mass of truly compelling interactive TV content. These problems have resulted in a deadlock that has prevented the advancement of the promise of interactive TV. Finding an inexpensive way for existing production companies to produce compelling interactive TV content and for TV multi-service operators (MSOs) to deliver it to TV viewers without imposing large new costs on them is thus the key to the advancement of interactive TV.

Interactive TV content can be produced inexpensively by existing TV production companies without radically changing their existing production methods by taking advantage of the vast base of existing non-interactive programs produced by such companies and converting them to interactive TV programs that engage viewers with “lazy” interactivity that does not detract from their entertainment experience. An example of “lazy” interactivity would be one in which viewers can point with a remote control unit and “click” on objects appearing in the screen display of a TV program to interact directly with the screen to trigger a finny response, play a game, receive information, or link to displays (windowed or overlay) of other video sequences. This kind of “lazy” interactivity keeps the viewers' experience entertaining by avoiding the need to operate a keyboard or to step through structured menus or long search sequences that are more typical of surfing Internet content on the TV.

In our U.S. Pat. No. 5,708,845, we disclose a method for readily converting existing media content to interactive media content by defining “hot spots” on a display of content and triggering an interactive response (new video sequence, pop-up message, graphic effects, etc.) when a viewer “clicks” on the “hot spots”.

In our U.S. patent application Ser. No. 08/933,666, we further disclose a method of detecting and processing a viewer's pressing of directional arrow buttons on a standard remote control to toggle to “haloed” objects on a TV display to “click” on “hot spots” in an interactive TV program.

In this U.S. patent application, we disclose additional methods for providing a visual interface to a viewer to “click” on “hot spots” in an interactive TV program using a standard remote control with a conventional TV set-top box.

### SUMMARY OF THE INVENTION

In accordance with the present invention, a system (and method) for converting existing TV content to an interactive TV program comprises:

(a) TV content in the form of a series of successive display frames in a time sequence which is transmitted to a TV set top box;

(b) object mapping data specifying display locations of objects as hot spots positions appearing in the display frames of the TV content to be rendered interactive which are transmitted to the TV set top box;

(c) an interactive TV utility program stored in the TV set top box which processes linkages from objects specified by the object mapping data to respective interactive functions to be performed upon viewer selection of the objects in conjunction with a display of the TV content; and

(d) a TV display system including the TV set-top box and associated remote control unit for receiving the transmitted TV content and object mapping data and operating the interactive TV utility program in conjunction with the display of the TV content by using the object mapping data to determine when the viewer is pointing to and selecting an object appearing in a display frame with the remote control unit and causing the interactive function linked by the corresponding linkage of the interactive TV utility program to be performed.

In the preferred embodiments, the hot spot positions may be specified as coordinate locations in the display area, or specified as marker positions in an HTML-type “page” that is parsed or overlaid in the display area. The system is especially adapted to use a standard remote control unit, which has directional arrow buttons and a Select button, as a pointing device. In one version, the interactive TV utility program generates a halo around each of the hot spot positions in the display frame, and when a directional arrow button on the remote is pressed, it highlights a haloed hot spot position and allow the viewer to select it. Continued pressing of the directional arrow button causes the highlighted area to toggle among the hot spot positions in turn.

In another version, the remote control unit is modified to transmit a series of directional button presses to the set top box, and the interactive TV utility program detects the signals and causes an on-screen cursor to move in corresponding directional increments in “staircase” fashion to a target hot spot position in the display area. In another version, the interactive TV utility program causes an on-screen cursor in a fixed reference point in the display area to aim in corresponding directional increments and illuminate a vector ray at a target hot spot position in the display area.

Another version has no “hot spots” but instead stores the positions of objects in the display area pointed to by the viewer and sends the click-stream data to a sponsor for the TV program.

### BRIEF DESCRIPTION OF THE DRAWINGS

FIG. 1 is a schematic drawing showing the conversion of existing TV content to an interactive TV program.

FIG. 2 is a schematic drawing showing the generation of object mapping data designating “hot spots” in a display frame.

FIG. 3 is a schematic drawing showing transmission of TV content and object mapping data from a cable TV server to a subscriber's TV set top box.

FIG. 4 is a schematic diagram of the components of a set top box for use in conjunction with an interactive TV program.

FIG. 5A is a procedural diagram for an object mapping tool for generating N Data for objects in a display frame,

FIG. 5B is a procedural diagram for an object motion tracking tool for generating N Data for objects in motion over a sequence of display frames, and

FIG. 5c illustrates use of the mapping and motion tracking tools for automatically generating N Data for an object in motion.

FIG. 6 is a schematic illustration of a disk storage format for TV content and object mapping data for an interactive TV video program on disk

FIG. 7a illustrates operation of an interactive TV utility program and remote control to allow a viewer to toggle through hot spots on a display, and

FIG. 7b illustrates transmitting secondary TV content for an interactive TV program in the video blanking intervals between video signals.

FIG. 8 is a schematic illustration of use of a modified TV remote control unit as a pointing device through “staircase” cursoring.

FIG. 9 is a schematic illustration of using a modified TV remote control unit to point to hot spots by aiming a vector ray at a selected hot spot.

### DETAILED DESCRIPTION OF THE INVENTION

Incorporated herein by reference is our disclosure in U.S. Pat. No. 5,708,845 of a method for converting existing media content to interactive media content by defining “hot spots” in a display frame of content to trigger an interactive response when a viewer “clicks” on the “hot spots”. An embodiment of a system for converting existing media content to interactive media content is described below.

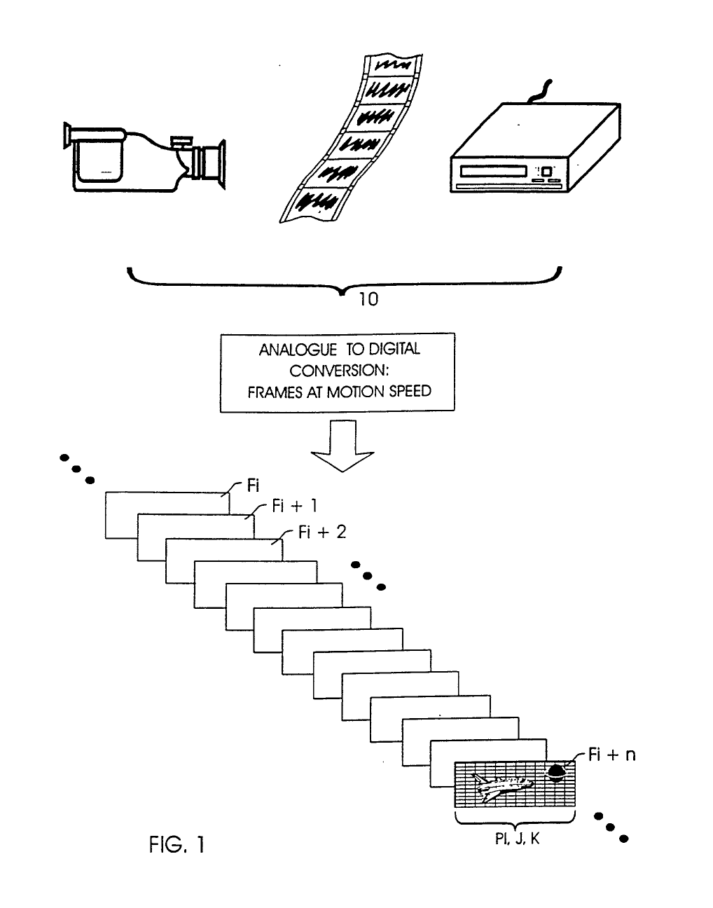

As illustrated in FIG. 1, original media content 10, such as a movie, video program, or live television program captured by a video camera, etc., is digitized via an analog-to-digital (A/D) converter 12 into digital data representing a series of display frames Fᵢ, Fᵢ₊₂, Fᵢ₊₃, . . . , in a time sequence t for display on a display screen. Each frame F has a frame address i, i+1, i+2, . . . corresponding to its unique time position in the sequence, and is composed of an array of pixels pᵢ uniquely defined by location coordinates represented by j rows and k columns in the display area of each frame. The pixels of the frame are also digitally defined with chrominance and luminance values representing their color and brightness levels on the display. For full motion video, a sequence of 30 frames is typically used per second of video.

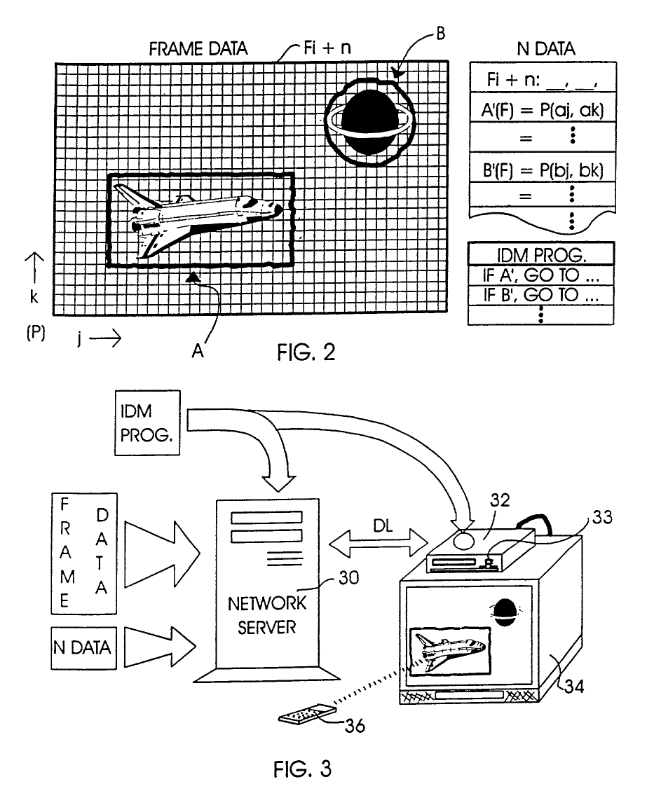

In FIG. 2, an individual frame is illustrated showing an image of an object A such as a face next to an object B such as the sun. In interactive use, the user can point at (click on) the face A or the sun B to connect to further information or a further development in the story being presented. In accordance with the invention, the original media content is converted to interactive use without embedding special codes in the digital data for the frames, by mapping the “hot spots” as separate data which are used in an interactive digital media program associated with the media content. Thus, for the frame Fᵢ, a “hot spot” area A′(Fᵢ) is mapped for the object A, and a “hot spot” area B′(Fᵢ) is mapped for the object B. The definition of a “hot spot” can be made by defining a set of pixels in the display which comprise an outline around the designated area, e.g., p(aⱼ,aₖ) . . . . Alternatively, the area may be defined by a vector contour encompassing the designated area, or any other suitable array definition method as is well known in the computer graphics field. The display location coordinates of the defined pixels and the frame addresses of the frames in which the area appears are stored separately as object mapping data.

The original media content is thus rendered in the form of a stream of digital data, referred to herein as “Frame Data”, which represent the series of display frames F constituting the movie or video sequence. Concurrently, for each frame Fᵢ, the object mapping data, referred to herein as “N Data”, are generated to define the display location coordinates of designated “hot spot” areas in the frames of the movie or video sequence. In accordance with a basic principle of the invention, the N Data mapping the “hot spots” are maintained as physically or at least logically separate data from the Frame Data for the media content. For example, the Frame Data and the N Data may be recorded as physically separate sectors on a video laserdisk or CD, or may be stored as logically separate data files in the memory storage of a video server. In this manner, the objects which are rendered interactive in the original media content are tagged for use in a compatible interactive digital media (IDM) program without embedding any proprietary or platform-dependent codes in the media content. Thus, the media content data can be run on any digital media player and the N Data can be used by any IDM program.

The N Data defining the “hot spots” are preferably in a standard industry format for the frame addresses and display location coordinates for the designated objects, as explained further herein. The standard-format N Data can thus be accessed by any interactive digital media (IDM) program written in standard applications programming languages. In accordance with the invention, the N Data define the location of the designated “hot spots” or “anchors” to which hyperlinks are established in the IDM program. This is represented in FIG. 2 by “IDM PROG.” which references the “hot spot” N Data values as anchors for hyperlinks to other files or executable functions (“GO TO . . .”). Then when a user clicks on a designated “hot spot” by pointing to any display position encompassed within the area defined by the object mapping data, the IDM program recognizes that the object pointed to has been selected, and consequently causes the other file or function linked to the “hot spot” to be performed.

Running Media Content and IDM Program from Network Server

Interactive digital media programs in accordance with the invention can be run on any of a wide range of platforms. In large media services networks, the media content, N Data, and associated IDM programs are downloaded via the network to user or subscriber terminals upon request. The following description focuses on the delivery of media content, N Data, and IDM program through a network, such as a cable TV network.

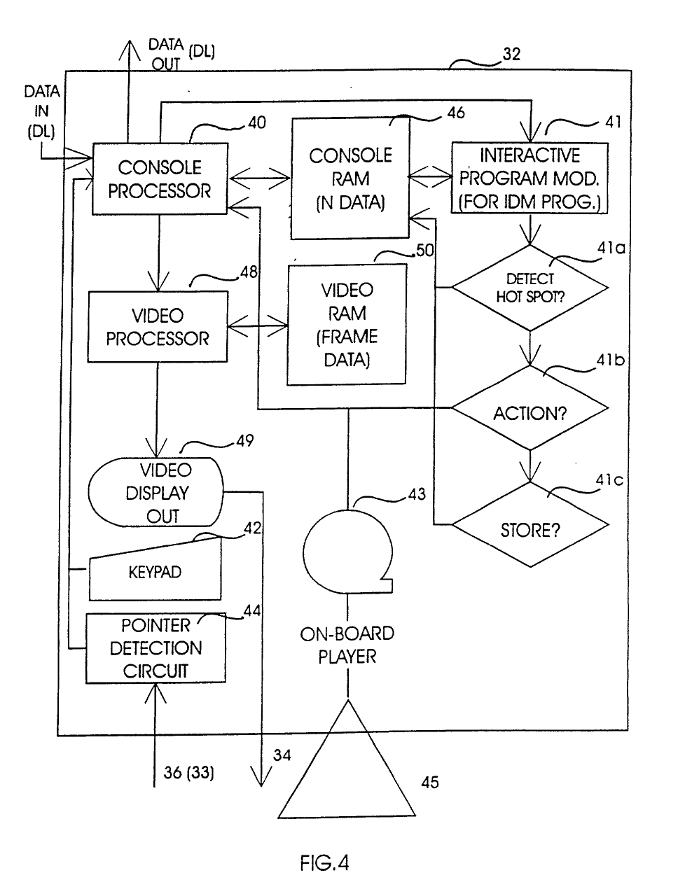

Referring to FIG. 3, a network server 30, such as a head-end server for a cable TV network, provides media services from a node or hub in a company's service area. The server 30 is coupled to subscriber terminals through a suitable data transmission link DL, such as cable wiring, fiber optic lines, telephone wiring, or digital data links. The subscriber's terminal is typically in the form of a “set-top” box 32 connected to the subscribers' TV or screen display 34, but it can also be a computer or other type of terminal. An important concept for network media services is “video-on-demand”, wherein the server 30 can access large digital libraries of movies, videos, and other types of media content and transmit them to subscribers upon request. The server 30 transmits both the Frame Data for the media content and the N Data and IDM program for rendering the “hot spots” therein interactive to the subscriber's set-top box 32 via the data transmission link DL. The subscriber uses a remote control device 36 to operate the set. For interactive use, the remote device 36 can include an optical pointer which emits an infrared or other light beam. As known conventionally, a sensor 33 in the settop box is used to detect the position and angle of the beam from the remote control pointer in order to detect the area of the display 34 being pointed to.

The media content with N Data delivered to the subscriber is operated interactively by the subscriber through the IDM program. The IDM program can be a dedicated program indexed to N Data which are specific to a single type of interactive use of the media content. Alternatively, a production studio or studio library which owns the media content property may find it more effective to publish a complete listing of N Data for an owned property which includes a mapping of all “hot spots” likely to be of interest for interactive programs. IDM program writers can then use the published listing of N Data to create many and more diverse program offerings for a particular media content property. For dedicated IDM programs, the IDM program data can be stored together with the N Data in association with the media content and transmitted together by the server 30 to the subscriber's terminal. For multi-use IDM programs, the N Data can be stored in association with the media content and transmitted from the server 30, while subscribers can choose any IDM program they wish to play from a publishing or retail outlet and load it into their terminals via a peripheral device provided with or connected to their set-top box 32, such as a CD-ROM drive or a ROM card insertion slot.

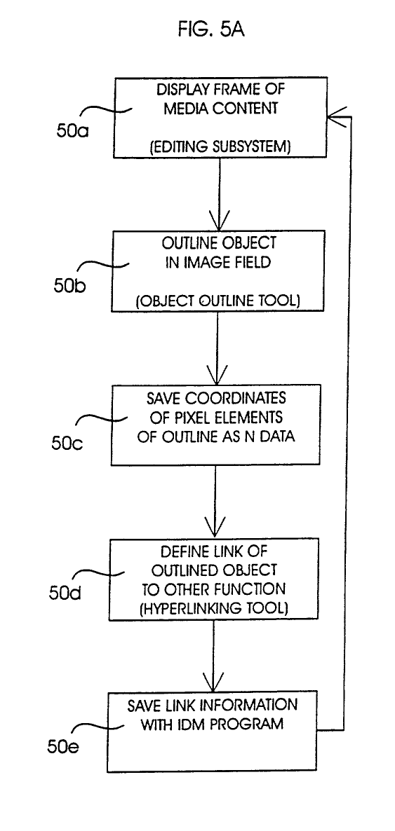

FIG. 4 illustrates schematically how an interactive digital media system uses the media content Frame Data, N Data, and the IDM program together to provide interactive entertainment. The system includes the aforementioned set-top box 32, display 34, remote control pointer 36, and data link DL to the external network server. An on-board CD-ROM player or other data reading device 43 may be provided with the set-top box 32 for input of data, indicated at 45, such as by loading from a selected CD or insertable disk or card. Input from the remote control pointer 36 is detected by the sensor 33 on the set-top box and processed to determine its target via a pointer detection circuit 44.

In the principal mode of use, the subscriber inputs a request to the service company for an interactive media program through the set-top box 32, using an on-board keypad 42 or through menu selection by using the remote control pointer 36. For example, the subscriber can request the interactive program “Movie Trivia Info” for the movie “The Maltese Falcon”. This interactive program will run the movie while displaying pop-up movie trivia about the stars Humphrey Bogart, Sidney Greenstreet, and Peter Lorre or objects such as the Maltese falcon whenever the user clicks on these “hot spots” appearing in different scenes of the film. To the user, movie viewing which had been a passive experience is rendered interactive so that the user can play trivia games or spark conversations in conjunction with the running of the movie.

A console processor 40 for the set-top box processes the subscriber request and transmits it via the data link DL to the network server 30. In return, the server 30 first transmits the IDM program data for “Movie Trivia Info” and the N Data for the movie to the subscriber's set-top box where the console processor 40 operates to store the data in a console RAM memory 46. The console processor 40 can load and run the IDM program as a multi-tasking function concurrently with other console functions, as indicated in FIG. 4 by the separate module 41. Alternatively, the IDM program can run on a separate processor (41) in parallel with the console processor.

After the IDM program is loaded, the network server 30 begins to transmit the movie as digital Frame Data to the subscriber's set-top box 32. The Frame Data is routed by the console processor 40 to the video processor 48 and associated video RAM memory 50 which process the display of frames of the movie via video display output 49 to the subscriber's television 34. Audio processing is subsumed with the video processing and is not shown separately. For typical video-on-demand servers, a requested movie can be transmitted to the subscriber as a series of 30-second movie blocks within a 6-minute start of a request. The video processor coordinates the receipt of the blocks of transmitted data into a display of video output which the user sees as a continuous movie.

As designed for interactive TV systems, the remote control 36 includes an optical pointer for digitally pointing to objects displayed on the television screen. As the movie runs, the user can point the remote control pointer 36 to a designated actor or object appearing on the television display and click on the desired object. The N Data for the movie defines the area encompassing the object as a “hot spot”. Clicking the pointer results in the target's display location coordinates being detected by the pointer detector module 44. The target's coordinates are input via the console processor 40 to the IDM program running concurrently with the movie. As indicated at box 41a, the IDM program compares the target's coordinates to the N Data mapping of “hot spots” stored in memory to identify when a “hot spot” has been selected, and then executes the response programmed by the hyperlink established for that “hot spot”, as indicated at box 41b.

For example, the interactive response may be to display trivia information about the actor or object clicked on. The IDM module retrieves the trivia information stored with the IDM program in memory and sends it to the console processor 40 to process a pop-up window, overlay display, audio track, etc., in conjunction with the movie. To illustrate, upon the user clicking on the Maltese falcon, the hyperlink established in the “Movie Trivia Info” program can initiate a linked display of text or graphics explaining the Maltese origins of the falcon in a pop-up window on the television screen, or may execute another program function such as initiating an Internet connection to a World Wide Web™ service which offers a replica of the falcon for purchase. In this manner, unlimited types and varieties of interactive actions can be activated for existing movies, videos, and other media content.

As an option, upon selection by a user clicking on an object, the IDM program can issue an instruction via the console processor 40 to the video processor 48 to slow down or pause the running of the movie to allow time for the user to absorb the IDM program response. Alternatively, the user may wish to bypass the response and store it to be reviewed after the movie is finished. By input from the remote control pointer 36 (e.g., clicking on a displayed “Save” button), the particular scene location and clicked object and/or its linked response can be saved in the console RAM 46 for retrieval during a Review mode of the IDM program, as indicated at box 41 c in FIG. 4.

Authoring and Mapping of “Hot Spots” As N Data

The mapping of “hot spots” or objects appearing in original media content to enable the operation of an interactive digital media (IDM) program is an important aspect of the present invention. In the production of an IDM program, the initial work of creating linkages between words, graphic images, objects, and/or scenes of a movie or video sequence to other interactive functions is referred to as “authoring”. An author typically works on a workstation using editing and hyperlinking software provided with various tools for working with particular media. An example of authoring software for multimedia programs is the PREMIER™ multimedia development system sold by Adobe Systems, Inc., of Mountain View, Calif. Such an authoring system is typically provided with editing tools which can be adapted as “hot spot” mapping tools for authoring IDM programs in accordance with the present invention.

Technology for mapping objects appearing in a display frame has been developed in the fields of interactive program development as well as for video editing. For example, the LINKSWARE™ hypertext development software offered by LinksWare Company, of Monterey, Calif., allows an author to click on a word or phrase in a text document and create a hyperlink to another file, and to store the linking information separate from the document itself. Video editing software sold under the name ELASTIC REALITY 3™ by Elastic Reality, Inc., of Madison, Wis., has shape creation and compositing tools which can outline a shape in an image field and store the shape data as a separate file.

The above described tools which are currently available can be adapted to the purposes of the present invention for authoring an IDM program by mapping “hot spots” in a media presentation. That is, using a shape outlining tool similar to that offered in the ELASTIC REALITY 3™ software, an object A as shown in FIG. 2 can be outlined with a cursor, and the display coordinate addresses for the pixel elements of the outlined shape can be stored in a separate file as object mapping data. Consequently, a hyperlinking tool similar to that offered in the LINKSWARE™ software is used to establish programmed hyperlinks of the object mapping data to other program functions which provide the IDM program with its interactive responses. The details of use of such editing and hyperlinking tools is considered to be within the realm of conventional technical ability and is not described in further detail herein.

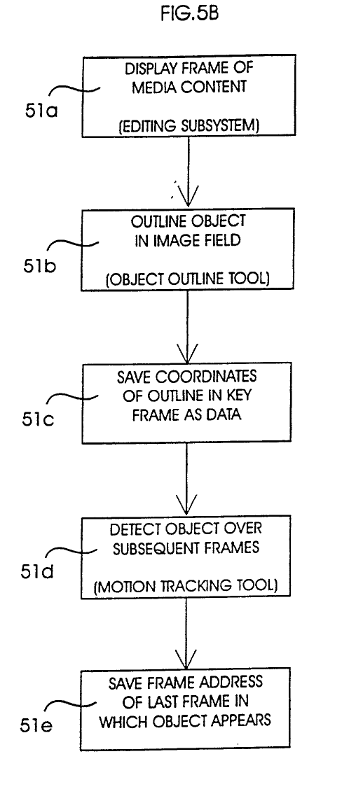

An example of a procedural sequence for using an object mapping tool in an authoring system is shown in the diagram of FIG. 5A. First, a display frame of the media content is called up on the editing subsystem, as indicated at box 50a. Using an outlining tool similar to that provided in the ELASTIC REALITY 3™ software, the author can draw an outline around an object in the image field using a pointer or other cursor device, as indicated at box 50b. The outline, i.e., the display location coordinates of the pixel elements constituting the outline, and the frame address are saved as N Data at box 50c. Then using a hyperlinking tool similar to that provided in the LINKSWARE™ software, the author can define a hyperlink between the object outlined, now specified as N Data, and another function to be performed by the IDM program, as indicated at box 50d. The hyperlink information is saved with the IDM program at box 50e. The procedure is iterated for all objects to be mapped in a frame and for all frames of the movie or video. The IDM program can be stored together with the N Data or separately, depending upon whether the N Data is for dedicated use or multi-use.

The object mapping function can use the same outline data of one frame for succeeding frames if the object appears in the same position in the other frames, i.e., is non-moving. This saves the author from having to draw the same outline in the other frames. Even further, the outline data of a non-moving object appearing in a first frame can be stored with only the frame address of the last frame in a sequence in which the object appears unchanged in order to compress the N Data required to map the object over the sequence of frames. The IDM program can later uncompress the N Data and use the same outline data for the sequence of frames.

The object mapping procedures can include a motion tracking tool for automatically generating N Data for an unchanging object in motion across a sequence of frames. It will be appreciated that the mapping of a number of “hot spots” in each frame of a full motion video sequence or movie which may run from a few minutes to a few hours duration can be a hugely laborious task. Motion tracking and motion estimating techniques have been developed recently which can be adapted for a motion tracking tool to be used in the invention. For example, a motion tracking program named ASSET-2 developed by Stephen M. Smith at the U.K. Defense Research Agency, Chertsey, Surrey, U.K., uses feature segmentation and clustering techniques to produce an abstracted cluster representation of objects in successive frames of a video sequence. Using statistical comparisons, a cluster characterized by a similar set of features appearing at different positions in a path across a series of frames can be recognized as an object in motion. The object can then be tracked to varying degrees depending upon the sophistication of the particular applications program, such as for traffic monitoring, target acquisition, etc. At the simplest level, an object in motion is detected if it is unchanging, i.e., is not rotating or being occluded by other objects in three-dimensional view. With more advanced techniques, the object can be recognized if it retains some recognized features while rotating or moving behind another object. A general description of motion tracking or motion estimating techniques is given in Machine Vision, by R. Jain, R. Katsuri, and B. Schunck, published by McGraw-Hill, Inc., New York, N.Y., 1995.

Another motion estimating technique is one used for compression of video images. MPEG-2 is a video compression standard developed by the Motion Pictures Expert Group, a committee of the International Standards Organization (ISO). MPEG-2 uses interframe predictive coding to identify pixel sectors which are invariant over a series of frames in order to remove the invariant image data in subsequent frames for data compression purposes. A general description of MPEG-2 and motion estimating techniques is given in Digital Compression of Still Images and Video, by Roger Clarke, published by Academic Press, Inc., San Diego, Calif., 1995.

An example of a procedural sequence for using a motion tracking tool in an authoring system is shown in the diagram of FIG. 5B. First, a display frame of the media content is called up on the editing subsystem, as indicated at box 51a. Using an outlining tool as before, the author draws an outline around an object and marks its position as it appears in a first or “key” frame, as indicated at box 51b. The outline data, position, and frame address are saved as N Data at box 51c. Then, a motion tracking tool similar to the ASSET-2 system of the U.K. Defense Research Agency or the MPEG-2 motion estimating technique is used to detect the image of the object as it moves across subsequent frames at box 51d, until a last frame in which the object is detected is reached. The position of the object and frame address of the last frame in the sequence are then saved as N Data at box 51e. The use of the motion tracking tool saves the author from having to draw the outline around the object in each frame of the sequence, and also compresses the amount of N Data required to specify the mapping of the object in those frames.

The use of the motion tracking tool for N Data generation in accordance with the present invention is illustrated in FIG. 5C. The author first brings up on the workstation a key frame F_{Ki} of a series of frames in a full motion movie or video sequence. Using a mouse or other type of pointing device 52, the author delineates an object in the key frame, such as the airplane shown in frame F_{Ki}, by drawing an outline OL around the airplane. The author also marks the position of the object in the key frame by designating a marker MK in a central position within the outline OL in frame F_{Ki}. The author then runs the motion tracking tool by clicking on an MT button of a tool bar 54 in a graphical interface for the authoring program. The motion tracking function operates to identify the object indicated to be within the outline OL in frame F_{Ki} where it appears in the succeeding frames of the sequence until a last frame F_{Ki+N} is reached in which the object is detected. The outline data and position of the object in the key frame and the position and frame address of the last frame are stored as N Data by the authoring system.

Alternatively, the authoring system can use a conventional editing tool for advancing through a sequence of frames and marking the position of the object as it moves across the frames until a last frame is reached. This allows a path P of motion to be specified in terms of the progression of positions of the marker MK for the object. For motion that follows a straight line or simple curve, the author can simply mark the outline OL and the marker MK in frame F_{Ki} and mark the end position of the marker MK in a selected frame N steps removed from the key frame. Smooth motion to the human eye can be approximated well by a display of image frames at the rate of about 30 frames/second. A typical selection for the number N of frames for following an object in motion smoothly might be an interval of 15 (0.5 second), 30 (full second), up to 60 (2 seconds) frames or more. The author thus advances to frame F_{Ki+N} and marks the position of the object in that frame. The path P can then be automatically filled in using a typical “in-betweening” function commonly provided in video editing software, such as the ELASTIC REALITY™ software, or a simple vector function. The outline and the path data are then stored as N Data.

With the above described object mapping and motion tracking tools, an author can readily outline a number of “hot spots” in a full motion sequence and generate N Data automatically over a series of frames. The automatic generation of N Data over extended time increments makes the mapping of objects in media content of long duration such as a two-hour movie a manageable task. When the N Data has been specified for the mapped objects, hyperlinks to other interactive functions can be readily established using conventional hypermedia authoring tools.

Distribution of Media Content and N Data

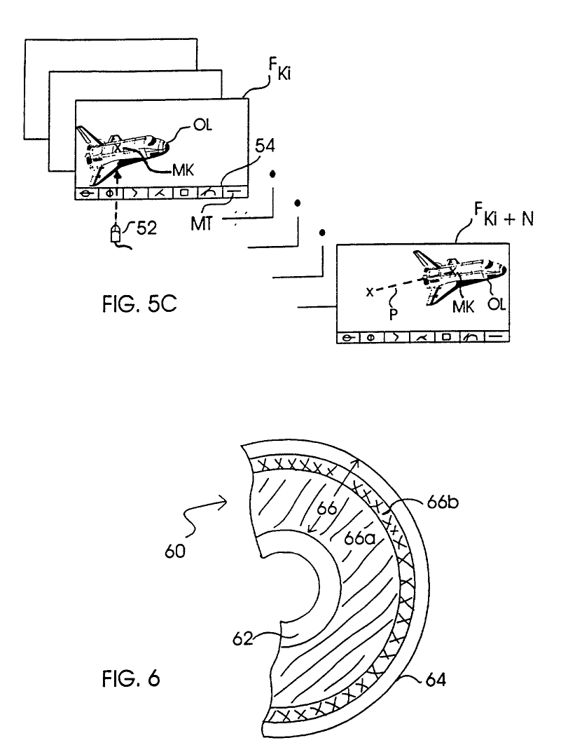

The N Data for marked objects are maintained as separate data from the media content so as to leave the latter uncorrupted by any embedded or proprietary codes. The IDM program with its hyperlinking information may be stored with the N Data or as a separate program depending upon whether the N Data is for dedicated use or multi-use. The transmission of media content and N Data, with or without the IDM program, has been described previously for a network. For product distribution and individual purchase, the media content and N Data (with or without the IDM program) are recorded in a unique format in a storage disk. An example of such a disk 60 is shown in FIG. 6 having a center hub 62 and an outer edge 64 with an optically readable data space 66 therebetween. Digital data for programs, sound tracks, video sequences, movies, etc., are typically stored as optically readable marks representing binary Is and Os in the data space 66. For media of smaller total data volume, e.g., 640 megabytes and under, the industry standard is a compact disc or CD which is written on one side. For larger data volumes up to 10 gigabytes and higher, such as for full-length movies and videos, laser disks of a larger size, and new disk formats of CD size with multiplied data density written on both sides, have been developed.

In FIG. 6, the media content data is shown stored in a large inner sector 66a, while the N Data is stored on a narrow outermost sector 66b. Isolating the N Data on the outer extremity of the disk in this way allows the disk to be used both in new players which can utilize the N Data for interactive programs, as well as in conventional players which simply playing back the non-interactive media content. The new disk players for interactive media content are configured to be able to read the outer N Data sector and retrieve the N Data for use in an IDM program. If the N Data is for dedicated use, then the IDM program may also be stored with the N Data in the outermost sector 66b. Using data compression techniques as described above, the N Data for media content of even a long duration can fit in a relatively small data space, thereby taking up only a small percentage of the total disk space.

Operating Interactive TV Program With Standard Remote Control and TV Set Top Box

Incorporated herein is our disclosure in U.S. patent application Ser. No. 08/933,666 of a method of detecting and processing a viewer's pressing of directional arrow buttons on a standard remote control to toggle to “haloed” objects on a TV display to “click” on “hot spots” in an interactive TV program.

The present invention allows the broad base of existing TV content in the form of movies, TV programs, videos, advertisements, etc. to be converted to interactive TV programs through the authoring of hot spots having interactive functions defined by their positions in the display and used to create entertainment interactive effects in conjunction with underlying TV programs. Existing TV content includes not only previously recorded movies, videos, shows, and ads, but also programs that are recorded live on film or videotape.

The ability to convert existing TV programs to interactive TV programs allows the existing base of TV content to be used as interactive TV content, and to be delivered through the viewing public through the existing broadcast and cable TV hardware and infrastructure to facilitate a gradual transition to all-digital TV in the future. This avoids imposing huge new costs on the TV production companies to create interactive content ahead of demonstrating the existence of a critical mass of viewer interest that can generate sufficient new revenues to justify those costs. It also avoids imposing huge new infrastructure, conversion, marketing, and customer support costs on MSOs. And it allows the viewing public to become familiar with the benefits and excitement of interactive TV programs without having to purchase expensive new equipment or radically change their TV viewing habits.

For example, home shopping shows can be rendered interactive by mapping the products displayed on the TV screen as hot spots to allow switching to or overlaying (in a window) additional information or follow-on options about the product selected by the viewer. The viewer's set top box can be downloaded with a stored product interaction program to perform basic functions expected for advertisements, infomercials, and home shopping shows, for example, sending a response back that the viewer is interested in buying the product or obtaining more information about it, displaying additional text and graphics concerning the product, or connecting to a related Web page on the Internet.

As another example, a TV program filmed live or transmitted on a taped delay may feature a number of speakers or entertainers. Rendering the talk show interactive can allow viewers to send responses back to the show or to obtain more information or trivia comments about the speakers or entertainers. Hot spot data mapping the speakers on the TV display can be downloaded with the TV program to the viewer's set top box. During the show, the viewer can click on one of the speakers, and the hot spot will trigger an interactive function, such as displaying the speaker's biography in a window, or send a vote supporting the speaker's viewpoint back to the show. If the set top box supports viewer input via a keyboard and has a modem connection, an on-line response can be sent by the viewer to the show.

As a further example, existing video content such as a music video can be enhanced with overlays of graphics, buttons, and other objects to be displayed, for example, as pop-up quotes or trivia questions or game-oriented graphics in conjunction with the music video. The overlays may be edited onto the original music video using standard multimedia or video editing tools, for example the Macromedia Director™ program. The enhanced TV content can then be rendered as an interactive TV program by mapping selected image and/or added (non-image) objects as hot spots, and transmitting the hot spot data to the viewer's set top box along with the enhanced TV content.

An example will now be described operating existing TV content converted to an interactive TV program using a standard remote control and set top box to allow viewers to interact with “hot spots” in the TV program. The conventional cable TV system widely used in many MSO service areas in the U.S. transmits TV programs in digital MPEG-2 compression format converted from analog media content. The MPEG-2 digital data are received by the subscriber's set-top box and converted to analog TV signals to generate the screen display in conventional (analog) TV sets. A standard type of set-top box in common use, such as the DCT-2000 or 2200 manufactured by Next Level, Inc., formerly General Instruments Corp., Philadelphia, Pa., includes a small microprocessor unit MPU and RAM memory and other components for handling basic programmed functions to be performed by the set-top box. The MPU can be re-programmed to perform other functions by downloading a software program to the set-top box through the cable line connection. In this manner, an IDM program for detecting viewer's “clicks” on “hot spots” in the display of the underlying TV program and generating the pre-programmed interactive response can be downloaded to the conventional set-top box and used to create the interactive effects in conjunction with display of the underlying TV program. Advanced digital set top boxes on two-way high-bandwidth cable TV networks are expected to be widely deployed in the future and will have much greater capability to handle more complex and experientially rich interactive TV programs.

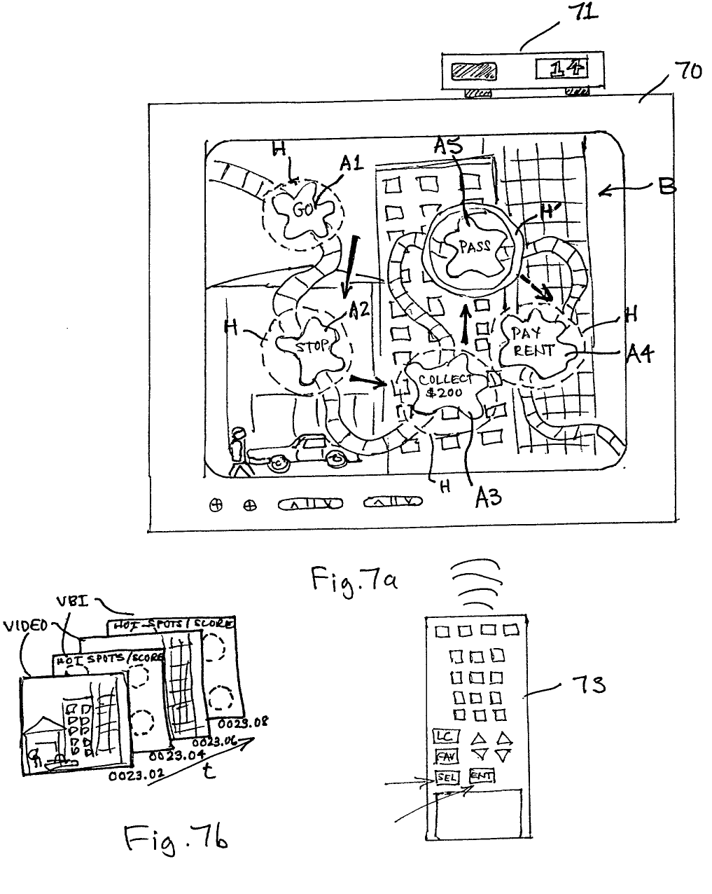

Referring to FIG. 7a, an example of an interactive TV program is shown displayed on a conventional TV set 70 connected by a conventional set top box 71 to a cable TV system. An IDM utility program is downloaded to the set top box 71 which consists of a defined set of functions that can be called to perform the various interactive functions of the interactive TV program. The interactive TV program displays an image B of a city with buttons A1, A2, A3, A4, A5 representing game options for an interactive game to be played by the viewer in conjunction with the story conveyed by the background image. The available game option buttons are “hot spots” identified visually for the viewer by a halo H displayed around the buttons. The halo H can be generated by a supplementary TV signal sent to the TV set's CRT gun to illuminate the area at the defined position of the “hot spot”.

Using a conventional TV remote control 73, the viewer can select one of the game options by toggling through them in sequence, for example, by pressing the “Select” key on the remote. As the viewer toggles through the options, the halo H is brightened, as shown with highlighted halo H′ for button A5, in order to identify the currently toggled button for the viewer. The viewer can select a currently toggled button by pressing the “Enter” key, for example, on the remote. This may result, for example, in an interactive effect such as a display to the viewer of a funny response or a score assigned to that button. A tally of the viewer's score is maintained by the IDM utility executed by the processor in the set top box 71. After the game is completed, the viewer's total score can be transmitted to the cable company's headend server, where it is recorded with the scores from other viewers on an output listing that is sent on to the sponsor of the interactive TV game. The sponsor can then send notification of a prize to the winner of the game.

Referring to FIG. 7b, an example is shown how interactive effects can be generated in the interactive TV program. The main sequence of the interactive TV game is represented schematically as a series of video signal frames VIDEO in time-indexed order (t). Conventional TV signals are transmitted at the rate of 30 frames per second. In between the VIDEO frames intervals referred to as video blanking intervals VBI which can be used to transmit secondary TV signals to the viewer's set top box. In older TV sets, the TV signals are transmitted as analog TV signals for each frame of the display, and the VBI is a blank interval between analog TV signals which may be used to transmit other analog signals as alternate TV frames or as analog signals that can be converted to digital data. In the example shown, the background image B of the city as video content are transmitted in the VIDEO frames, while the hot spot data identifying the positions of the available game option buttons A1, A2, A3, A4, A5 on the display are transmitted in the VBI along with the interactive displays of the response or score obtained in that game segment. The hot spot data may be in the form of coordinate locations of the buttons. The hot spot data are stored and halos generated by the IDM utility loaded in the set top box. Alternatively, the hot spots may bein the form of a screen overlays of the buttons and halos in their respective positions.

The frames of video signals are time-addressed using the SMPTE time code synchronization protocol widely used in the television and motion picture industry. SMPTE Time Code provides a unique time address for each frame of a video signal. This address is standardized as an eight-digit number based on the 24-hour clock in hours, minutes, and seconds and the video frame rate per second. There are four standard frame rates (frames per second) that apply to SMPTE Time Code: 24, 25, 30, and 30 “Drop Frame”. SMPTE time code can be recorded as digital signals recorded longitudinally on a track of an audio or video tape or recording media, or can be encoded in the video signal frame-by-frame during the vertical blanking interval VBI between frames. If the SMPTE Time Code is not transmitted with the video signal, it can be supplied by the equipment that processes the received video signal which, in this case, is the interactive TV utility stored in the set top box.

The interactive TV program can thus be supplied through existing cable TV channels by sending the TV content in the VIDEO frames and the hot spot data and interactive displays data (indexed to SMPTE Time Code) in the VBI to the viewer's set top box. Alternatively, the hot spot data and interactive displays can be transmitted on the same cable channel prior to the interactive TV program, or on a separate frequency band, an available side band of the assigned cable TV spectrum, or other distribution channel including an online TCP/IP connection to Internet sources. The interactive use of hot spots with cable TV signals on current cable equipment in widespread use may be limited to pop-up and other overlay effects, since cable TV signals are generally broadcast as streaming, non-interruptible content. More advanced digital set top boxes capable of handling video-on-demand and pay-per-view have VCR-like functions that can pause the TV content and/or bookmark the hot spots.

The toggling function can be implemented with conventional cable TV set top boxes and remote controls in a manner similar to that currently used to display and control on-screen menus such as volume control, for example. The on-screen menu is downloaded to the set top box by the cable company as part of the subscriber's cable control package. When the viewer presses a volume control button on the remote control, the volume on-screen menu is displayed on the TV screen superimposed over the TV program currently being viewed. The usual volume control menu consists of a series of bar segments at fixed position intervals representing the volume level. As the viewer presses the volume-up or volume-down buttons, the display toggles through the bar segments in up or down sequence and highlights the currently toggled segment. In a similar manner, the hot spot objects can be overlaid with halos H and toggled through with highlighting by pressing the “Select” and “Enter” keys on the remote control.

The sponsor or producer of the interactive TV program may use the authoring system described above to generate the hot spot data and interactive fimctions when creating the enhanced TV content for the interactive TV game. As examples, pre-recorded sports programs, news telecasts, performance telecasts, TV commercials, product infomercials, etc. can be authored with hot spot data using the outlining and tracking functions described above for taped video frames in analog format. Since the hot spot data is maintained logically separate from the TV content, it does not matter what form, signal or file format the TV content is provided in or what set top box system or display platform it is run on. Therefore, the current diversity of sources for generating and distributing media content can continue to be utilized in conjunction with the authoring of interactive TV programs for delivery on conventional cable TV systems.

When TV content is rendered interactive with an IDM program using “hot spot” position data, it may be desirable to stop, pause, rewind, or otherwise control the playback with familiar VCR-like controls to allow the user time to interact with the program, such as for reading information, making choices, inputting information, following a hyperlink from the hot spot, or saving a marked hot spot for later review. VCR-like controls have been developed for use with most types of multimedia systems. For example, in video-on-demand or media-on-demand systems, “streaming” content supplied in segments of digital data packets can be controlled with VCR-like controls by interrupting the content stream upon sending a command from the subscriber and rescheduling the sending of content segments as requested by the subscriber. Such video server scheduling techniques and handling of interactive requests from a video-on-demand network may be used in conjunction with interactive TV programs as described herein.

When a user clicks or points at a hot spot in interactive TV content, it may be desirable to provide a “bookmark” or “frame storage” function so that the user can store the hot spot object for later review and follow up. For systems in which the TV content is supplied locally from a disk or other video player, a bookmark function can be implemented in accordance with known techniques for storing the address of the frame and the position of the hot spot pointed to by the user, for later playback and interactive use in accordance with the IDM program. For cable TV systems having video-on-demand functions, a frame storage function can be implemented with available video console memory to store the entire image frame and hot spot position in RAM for later playback and interactive use.

Use of HTML-type Formatting to Define Hot-spots

The locations of hot spots in a display of an interactive TV program can be defined by other measures equivalent to coordinate data. For example, hot spot locations can be defined by vectors or by positions in a “page” equivalent to the display screen. Most attempts to create interactive TV effects have focused on embedding hyperlinks in digital video files, which is the approach specifically avoided herein. Instead, the examples described below provide other methods of defining the positions of hot spots by an adjunct definition of “position markers” that are not embedded in the underlying TV content.

One relevant approach is that of the Advanced TV Enhancement Forum (ATVEF), which is defining protocols for the use of HyperText Markup Language (HTML) in television applications, as is the World Wide Web Consortium. The Internet Engineering Task Force is developing protocols for video and audio transport over Internet links that may also be relevant to these applications. ATVEF is a standard for creating HTML-type formatted content that can be delivered to a wide range of television, set-top box, and other display devices over a variety of mediums—including analog (NTSC) and digital (ATSC) television broadcasts—and a variety of networks, including terrestrial broadcast, cable, and satellite.

By defining the standards used to create enhanced content, the ATVEF specification also defines the minimum functionality required by ATVEF receivers to parse and display this content. One of the major goals of ATVEF was to create a specification that relies on existing and prevalent standards, so as to minimize the creation of new specifications. The content specification is based around existing Internet technologies such as HTML and Javascript. Because the content specifications are fully web compatible, there already exist millions of pages of potential content. Considering how easy it is to use many of today's web-authoring tools, practically anyone can become an ATVEF content developer.

In the present invention, AVTEF can be used to create a Web-based definition of hot spot position markers, then used as described previously in conjunction with underlying TV content. For example, a transparent “page” (which could also contain text and graphics) can be created in HTML with the N-data for the hot spots in the video content being defined in an image map in HTML code. Using the ATVEF protocol, the “page” can be transmitted to the STB as digital data through the VBI, side channel, or out-of-band channel to the main channel carrying the underlying TV content. The AVTEF “page” can then be processed by the STB's MPU as a hot spot map, or as a transparent screen overlay that is separate from the underlying video content. As a hot spot map, the hot spot position markers in the AVTEF “page” can be parsed by the MPU and used to identify the locations of hot spots in the display of video content. A video signal can then be generated to control the CRT gun to “halo” or highlight the designated positions on the screen. As a screen overlay, the AVTEF “page” can be converted to a video signal as an overlay of haloed or highlighted positions on the underlying video image. The hot spot positions in the AVTEF “page” are computed for a given aspect ratio of screen height and width and resolution of the host TV display.

The parsed and computed hot spot positions are stored as N data and processed by the IDM utility to determine when the viewer has “clicked” on one of the positions, e.g., by toggling to one position and pressing “Select” on a standard remote as previously described. It is important that the hot spot map or screen overlay be synchronized with the corresponding display of the underlying video content, which can be done using the SMPTE time codes for the display frames of the underlying content. The viewer can then synchronously point (toggle) to and click on haloed objects in the video display and trigger interactive responses. Thus, interactive effects can be obtained with a conventional TV set top box without the use of embedded hyperlinks in the content as commonly employed in PC digital media programs or Web pages.

Other systems of HTML-type formatting, such as DVB-HTML, a protocol promoted by Philips Corp. and Sun Microsystems, Inc., Mountain View, Calif., may similarly be used for non-embedded definition of hot spots designated for the underlying TV content.

If the viewer “clicks” on a “hot spot”, the IDM program parses the corresponding interactive effect linked with the detected hot spot and carries out whatever has been encoded. For example, the effect could be a link to an external URL, and an external Web page can be retrieved for display in a window superimposed on the underlying TV content. The effect may also be to display a response message, such as informing the viewer of a correct or incorrect selection, or a reward or point tally. The effect can also be to send a response signal to the cable head-end of the viewer's choice from options offered in the display, which is then forwarded to the advertiser or program sponsor for a follow up action or for measuring viewer responses and preferences. The forwarded data can be used by the advertiser or program sponsor for targeted advertising or individualized TV programming directed to the viewer.

Facilitating Individualized TV

The use of formatted HTML-type pages to define “hot spots” for interactive effects can reduce the amount of TV channel bandwidth required to implement “individualized TV”. Current proposals for “individualized TV” call for transmitting several simultaneous TV displays or Web pages through a TV channel band to the viewer's TV set, then having one TV display or Web page selected for display by a trigger which is set in the viewer's STB in accordance with the viewer's previously detected demographic type or viewing habits. The viewer's interaction with the individualized display or page is then recorded by the advertiser or sponsor. With the above-described method, a single HMTL-type page can be sent with several hot spot options designated on the display and the viewer's selection can be processed without having to transmit several simultaneous TV programs customized to different viewer demographics.

Sending Click Data Upstream

A converse adaptation of the invention system is to detect the viewers' pointing at objects in a TV display and send them as “reverse hot spots” upstream to the cable head-end, and ultimately to the vendor or advertiser. This would require the use of a mouse or other pointing device, so that the viewer can “click” on a position in the display, and the STB detector program then correlates the screen coordinates ofthe position pointed at with the program time and frame time code for the TV program being run. This “click-stream” data represents information about what objects the viewer is interested in and can be sent to the program sponsors or advertisers for marketing or programming purposes. More detailed “click-stream” data can thus be generated than is currently available from channel-surfing monitoring systems or systems that merely record a click selection from a drop down menu or grid. The system can also deliver a response message to the TV viewer, such as contact information or prompting the viewer to a further response.

Some producers that may find it valuable to know what viewers are clicking on, with or without hot spots in the program. For example, a TV ad can say “click on any item you are interested in”, then “Thank you for your selection. The information you requested will be sent to you”. When the advertiser receives the click data, the advertiser can follow up with a mailer to the viewer. This would allow even “no-spot” ads to be run, to make it easier for advertisers who do not create interactive ads to nevertheless get interactive responses from viewers. As a further example, the “no-spot” data can be sent to the advertiser's Web response site in real time, and the advertiser can follow up with a response delivered as an AVTEF page in real time that is displayed on the viewer's screen.

“Staircase” Cursoring Using the Standard Remote Control

While there has been many proposals for remote pointing devices to operate interactive TV, they all generally require the production of new hardware, such as, for example, optical beam pointers, light pens, joysticks, thumbwheels, mice, cursor discs, etc., which add to the cost of the system, and also require the distributor (cable TV companies) to distribute new hardware to thousands of customers and train them to use it. In another aspect of this invention, described below, the standard remote control can be adapted to function like a pointing device for interactive TV functions, so that no new hardware needs to be distributed and little training of viewers to use it is required.

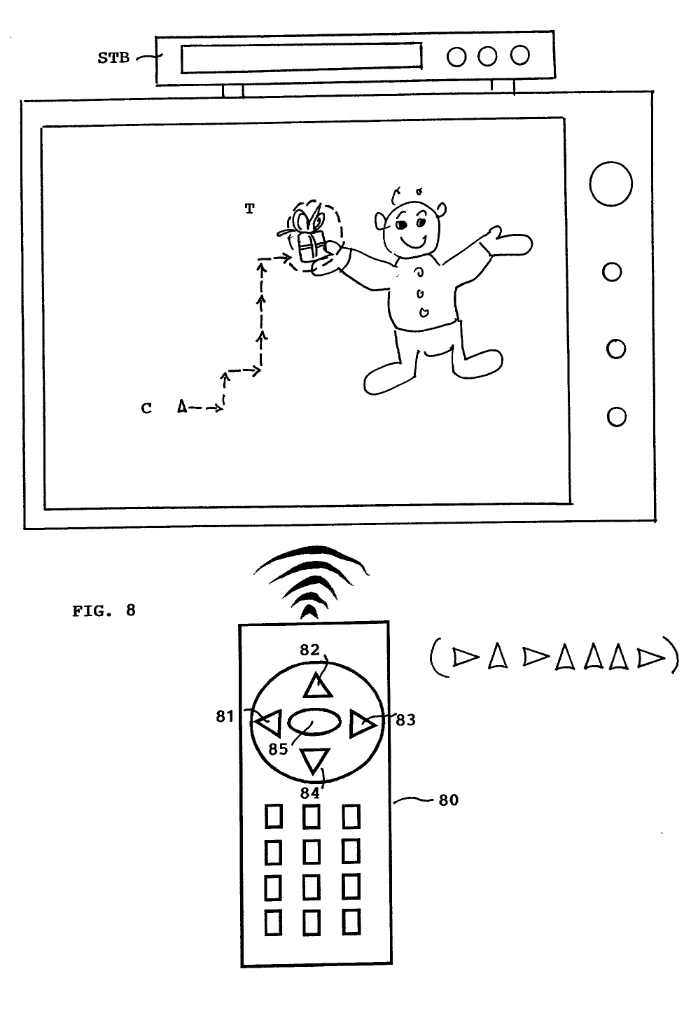

As shown in FIG. 8, standard types of remotes 80 in common use have 4 directional arrows 81, 82, 83, 84 (<, ˆ , >, v) and a Select button 85. If they are the older type that do not have Up/Down and Left/Right directional buttons, they have Up/Down Volume and Up/Down Channel buttons that can be adapted for on-screen directional movements. The current types of conventional set top boxes (STBs) that are widely deployed use IR beam transmission from the standard remote to send signals to the STB. When a button on the remote is pressed, an IR pulse signal is emitted that is detected by an IR sensor at the STB. The STB detector software decodes the received signal and outputs the corresponding control signals to control the STB in accordance with the button pressed. In order to prevent users from pressing buttons too quickly and getting lost as to which control signal they are sending, the detector program has a time lapse threshold that ignores a signal if it is pressed too quickly after a previous one.

By downloading a software utility to the STB from the cable head-end, the software threshold can be shortened to allow users to press a series of button presses in sequence and have them detected by the STB. In addition, the detector program can be modified to interpret a directional button press in a selected mode to be interpreted as a small incremental jump in that direction. In this manner, rapid pressing of the 4 directional buttons can move a screen cursor in jumps in the 4 directions. The on-screen cursor can thus be moved to any position on the TV screen. For diagonal movement, the user can press a combination of two perpendicular directional buttons to move the cursor in a “staircase” fashion. In the example shown in FIG. 8, pressing the Right, Up, Right, Up, Up, Up and Right arrow buttons moves an on-screen cursor C from its present position to reach a target position T of a “gift” held by a clown on the screen. When the viewer presses the Select button 85, an interactive effect associated with the “gift” can be triggered, such as a “You Have Won . . . ” display.

For older analog STBs or early digital STBs in which the detector function is implemented in a circuit board, the user would have to turn in their STB for upgrade or insertion of a replacement board. However, this would allow the embedded hardware costs in older STBs to extend to fuller cost recovery.

Vector Cursoring Using the Standard Remote Control

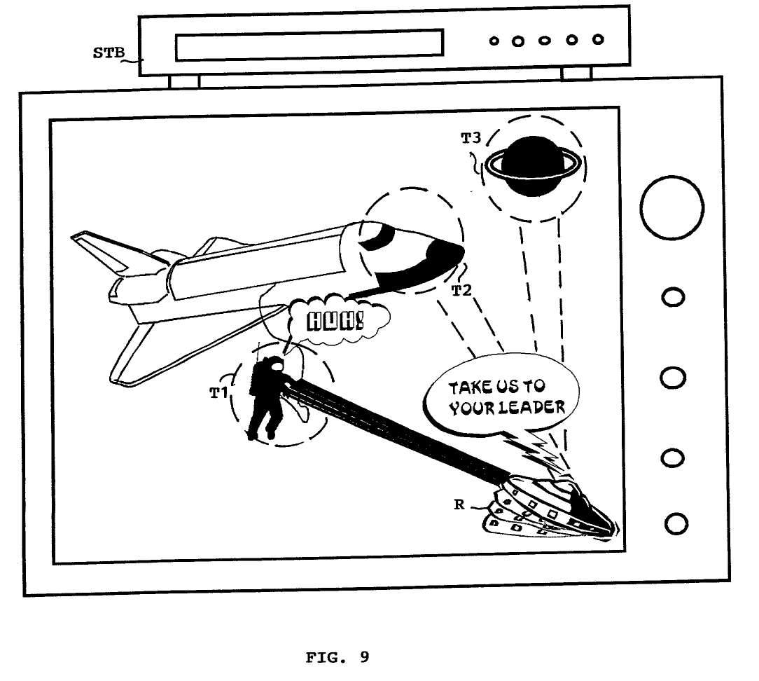

Another method provided in the present invention to adapt the standard remote control pointing to “hot spots” in an interactive TV program is to use a type of vector cursoring. In the example shown in FIG. 9, the interactive TV program has a graphic image of a flying saucer that serves as a reference point R in the lower right hand corner of the TV screen. One end of the graphic remains fixed in the corner of the TV screen, while the other end pivots 90 degrees from horizontal to vertical. By pressing the “Up” or “Down” buttons on a standard TV remote control, the viewer causes the free end of the graphic to move up or down in small increments enabling it to “point” at objects in the TV program as they are displayed on the screen.

When the free end of the graphic “points” at an object the viewer wishes to target, T1, T2, T3, etc., the viewer can press the “Enter” key on the remote and cause a vector graphic (in this example, a shot from a ray gun) to be overlaid on the video content and to “jump” across the TV screen. The viewer may be asked to locate and target certain objects in the video content that have been associated with “hot spots”. When the viewer accurately aims the “pointer”, presses “Enter” and causes the vector graphic to intersect the targeted object associated with a “hot spot”, an amusing graphic (in this example, a thought or speech “balloon”) or sound is overlaid on the video content. This may also result, for example, in the viewer gaining a score assigned to the targeted object. A tally of the viewer's score may be maintained by the interactive TV utility executed by the processor in the set top box. After the game is completed, the viewer's total score may be sent to the cable company's headend server, where it is recorded and sent to the sponsor of the interactive TV game. The sponsor can then send notification of a prize to the viewer. The reference point and vector ray may be a whimsical object such as a snake or frog that sends a tongue out to a target hot spot.

Another example consists of a graphic overlay (such as the flying saucer) which functions as a cursor the viewer can move in small increments either horizontally or vertically across the TV screen by sequentially pressing the four directional buttons on the remote or diagonally across the TV screen by pressing a combination of two perpendicular directional buttons to move the cursor in a “staircasing” fashion. When the “cursor” intersects an object in the video content associated with a “hot spot”, the viewer can “click” on the object by pressing on the “Enter” button and cause a graphic or sound to be overlaid on the video or cause the interactive TV application to launch a Web page associated with the object. Alternatively, merely the intersection of the “cursor” with an object associated with a “hot spot” could cause a graphic or sound to “pop-up” without the necessity of pressing on “Enter” to “click” on the object.

Although the invention has been described with reference to the above-described embodiments and examples, it will be appreciated that many other variations, modifications, and applications may be devised in accordance with the broad principles of the invention disclosed herein. The invention, including the described embodiments and examples and all related variations, modifications, and applications, is defined in the following claims.

1. A system for converting existing TV content to an interactive TV program comprising:
(a) TV content in the form of a series of successive display frames in a time sequence which is transmitted to a TV set top box;
(b) object mapping data specifying display locations of objects as hot spots positions appearing in the display frames of the TV content to be rendered interactive which are transmitted to the TV set top box;
(c) an interactive TV utility program stored in the TV set top box which processes linkages from objects specified by the object mapping data to respective interactive functions to be performed upon viewer selection of the objects in conjunction with a display of the TV content; and
(d) a TV display system including the TV set-top box and associated remote control unit for receiving the transmitted TV content and object mapping data and operating the interactive TV utility program in conjunction with the display of the TV content by using the object mapping data to determine when the viewer is pointing to and selecting an object appearing in a display frame with the remote control unit and causing the interactive function linked by the corresponding linkage of the interactive TV utility program to be performed.

2. A system for converting existing TV content to an interactive TV program according to claim 1, wherein the hot spot positions are specified as coordinate locations in the display area.

3. A system for converting existing TV content to an interactive TV program according to claim 1, wherein the hot spot positions are specified as marker positions in an HTML-type “page” that is parsed or overlaid to display the hot spot positions in the display area.

4. A system for converting existing TV content to an interactive TV program according to claim 1, wherein the remote control unit has directional buttons and a selecting button that are adapted as a pointing device.

5. A system for converting existing TV content to an interactive TV program according to claim 4, wherein the interactive TV utility program generates a halo around each of the hot spot positions in the display frame, and detects a signal from the standard remote control unit from pressing a directional arrow button and causes the display to highlight a haloed hot spot position and allow the viewer to select the highlighted hot spot position.

6. A system for converting existing TV content to an interactive TV program according to claim 5, wherein the interactive TV utility program detects a series of signals from the standard remote control unit from pressing a directional arrow button to highlight the hot spot positions by toggling among them in turn.

7. A system for converting existing TV content to an interactive TV program according to claim 4, wherein the remote control unit is modified to transmit a series of directional button presses to the set top box, and the interactive TV utility program detects the remote control signals and causes an on-screen cursor to move in corresponding directional increments in “staircase” fashion to a target hot spot position in the display area.

8. A system for converting existing TV content to an interactive TV program according to claim 4, wherein the remote control unit is modified to transmit a series of directional button presses to the set top box, and the interactive TV utility program detects the remote control signals and causes an on-screen cursor in a fixed reference point in the display area to aim in corresponding directional increments and illuminate a vector ray at a target hot spot position in the display area.

9. A system for converting existing TV content to an interactive TV program according to claim 8, wherein the reference point and vector ray is a whimsical object such as a snake or frog that sends a tongue out to a target hot spot position.

10. A system for converting existing TV content to an interactive TV program comprising:
(a) TV content in the form of a series of successive display frames in a time sequence of a TV program which is transmitted to a TV set top box;
(b) an interactive TV utility program stored in the TV set top box which processes linkages from objects selected by the viewer in a display frame as “reverse hot spot” data representing the positions of the selected objects in the display frame and the time sequence of the display frame in the TV program; and
(d) a TV display system including the TV set-top box and associated remote control unit, wherein the remote control unit has directional buttons and a selecting button and is adapted as a pointing device by sending signals from pressing the directional buttons and/or selecting button to the TV set top box, and the TV set top box is adapted to detect the signals sent from the remote control unit and cause an on-screen cursor to move in corresponding incremental directions to a target object and cause provide an output of selection of the target object to the interactive TV utility program, which processes the “reverse hot spot” data for the selected object.

11. A system for converting existing TV content to an interactive TV program according to claim 10, wherein the TV set top box is further operative to send the “reverse hot spot” data as an output via a data connection to a sponsor for the data.

12. A system for converting existing TV content to an interactive TV program according to claim 10, wherein the TV set top box is connected to a cable TV system, and the “reverse hot spot” data are sent upstream from the set-top box to a head-end for the cable TV system, and ultimately to a sponsor or advertiser for the TV program.

13. A method for converting existing TV content to an interactive TV program comprising:
(a) providing TV content in the form of a series of successive display frames in a time sequence;
(b) providing object mapping data specifying display locations of objects as hot spots positions appearing in the display frames of the TV content to be rendered interactive;
(c) operating an interactive TV utility program in a TV set top box to process linkages from objects specified by the object mapping data to respective interactive functions to be performed upon viewer selection of the objects in conjunction with a display of the TV content; and
(d) operating a TV display system including the TV set-top box and associated remote control unit to display the TV content and use the object mapping data to determine when the viewer is pointing to and selecting an object appearing in a display frame with the remote control unit and cause the interactive function linked by the corresponding linkage of the interactive TV utility program to be performed.

14. A method for converting existing TV content to an interactive TV program according to claim 13, wherein the hot spot positions are specified as coordinate locations in the display area.

15. A system for converting existing TV content to an interactive TV program according to claim 13, wherein the hot spot positions are specified as marker positions in an HTML-type “page” that is parsed or overlaid to display the hot spot positions in the display area.

16. A system for converting existing TV content to an interactive TV program according to claim 13, further comprising adapting the remote control unit with directional buttons and a selecting button as a pointing device.
